(19) United States
(12) Patent Application Publication
(10) Pub. No.: US 2005/0088634 A1
(43) Pub. Date: Apr. 28, 2005

(54) Exposure system and device production process

(75) Inventors: Junichi Kosugi, Fukaya-shi (JP); Tetsuo Taniguchi, Ageo-shi (JP); Naoyuki Kobayashi, Fukaya-shi (JP); Yoshitomo Nagahashi, Takasaki-shi (JP)

Correspondence Address: OLIFF & BERRIDGE, PLC, P.O. BOX 19928, ALEXANDRIA, VA, 22320, US

(73) Assignee: Nikon Corporation, Tokyo (JP)

(21) Appl. No.: 10/938,633

(22) Filed: Sep. 13, 2004

Related U.S. Application Data
(63) Continuation of application No. PCT/JP03/03003, filed on Mar. 13, 2003.

(30) Foreign Application Priority Data
Mar. 15, 2002 (JP) P 2002-072640
Jan. 8, 2003 (JP) P 2003-002285

(51) Int. Cl. G03B 27/52

(52) U.S. Cl. 355/30; 355/53

(57) ABSTRACT

The exposure system of the present invention inhibits baseline shift by carrying out temperature control as required by each composite equipment. This exposure system has a first control system that that sets the temperature of a first liquid, and controls the temperature of an object by circulating the first liquid for which the temperature has been set through at least one object of a projection optics and a substrate stage, and a second control system that sets the temperature of a second liquid independent from the first control system, and controls the temperature of a reticle stage by circulating the second liquid for which the temperature has been set through the reticle stage. The first and second control systems have mutually different setting capacities with respect to the size of the temperature range when setting the temperatures of the liquids.

### TECHNICAL FIELD

The present invention relates to an exposure system that projects and exposes a master pattern onto a wafer or other substrate in a device production process for semiconductor devices, liquid crystal display devices and so forth, and a device production process in which a device pattern is transferred to a substrate.

The present application is based on Japanese Patent Application Nos. 2002-72640 and 2003-2285, the contents of which are incorporated in the present description.

### BACKGROUND ART

When producing a semiconductor device or liquid crystal display device and so forth in a photolithography process, a projection and exposure system is used that projects a pattern image of a photomask or reticle (to be generically referred to as a reticle hereinbelow) into each shot region on a photosensitive substrate by means of projection optics. In recent years, this type of projection and exposure system consists of placing a photosensitive substrate on a two-dimensionally movable stage, moving the photosensitive substrate by moving this stage, and repeating an operation in which each shot region on a wafer or other photosensitive substrate is exposed to the reticle pattern image. These so-called step-and-repeat exposure systems such as reduced projection type exposure systems (steppers) are widely used. More recently, so-called step-and-scan exposure systems are also being used that sequentially expose each shot region on a wafer by synchronously moving the reticle and wafer during wafer exposure.

For example, since a semiconductor device or other microdevice is formed by using a photosensitive substrate and layering a large number of circuit patterns on a wafer coated with a photosensitive material, when projecting and exposing the circuit pattern starting with the second layer onto the wafer, it is necessary to align each shot region where a circuit pattern is already formed on the wafer with the pattern images of reticles to be exposed, or in other words, it is necessary perform alignment of the wafer and reticle precisely. For example, a common example of a system in which the wafer is aligned when overlaying and exposing a single wafer in which shot regions where circuit patterns are to be exposed are arranged in the form of a matrix is the so-called enhanced global alignment (EGA) system disclosed in Patent Document 1.

The EGA system is a positioning system in which at least three shot regions (to be generically referred to as EGA shots) are designated from among a plurality of shot regions formed on a wafer (object), and the coordinate position of an alignment mark (mark) provided for each shot region is measured with an alignment sensor. Subsequently, error parameters (offset, scale, rotation and orthogonality) relating to arrangement characteristics (positional information) of the shot regions on the wafer are determined by statistical processing using the least squares method and so forth based on measured values and design values. The design coordinate values are then corrected for all shot regions on the wafer based on the determined parameter values, the wafer stage is then stepped according to the corrected coordinate values to position the wafer. As a result, the projected image of the reticle pattern and each of the plurality of shot regions on the wafer are exposed by being accurately overlaid at processing points (reference points for which coordinate values are measured or calculated such as in the center of the shot regions) set within the shot regions.

A known method of the prior art used an off-axis type of alignment system arranged in the vicinity of the projection optics as an alignment sensor for measuring alignment marks on a wafer. In this method, after measuring the positions of alignment marks using the off-axis type of alignment system, the reticle pattern was able to be exposed directly while accurately overlaying the shot regions of a wafer simply by feeding the wafer stage by a fixed amount relating to a baseline amount which was the distance between the projection optics and the off-axis alignment system. In this manner, since the baseline amount is an extremely important operational quantity in the photolithography process, extremely accurate measurement values are required.

However, there is the risk of the aforementioned baseline amount shifting during exposure (baseline shift) due to the occurrence of thermal expansion and thermal deformation in the alignment system and so forth caused by heat generated accompanying each type of processing. In this case, since error occurs in wafer positioning that has the possibility of having a detrimental effect on overlay accuracy, deterioration of overlay accuracy was prevented in the prior art by periodically checking the baseline for every predetermined number of wafers (Japanese Unexamined Patent Application, First Publication No. 61-44429).

However, the aforementioned exposure systems and device production processes of the prior art still had the problems described below.

In recent years, step-and-scan types (to be simply referred to as scan types) of exposure systems have become the mainstream as opposed to step-and-repeat types accompanying increases in pattern fineness. Since scan types scan both the wafer and reticle during exposure (during pattern transfer), both the wafer stage and reticle stage become susceptible to retaining heat due to the effects of the motors and so forth, gradually causing deformation in the stages and surrounding components.

Although stage position is measured using an interference system, if the distance between a moving mirror and reticle change due to deformation of the stage, the baseline ends up shifting resulting in poor overlay accuracy. In addition, since the temperature of the atmosphere surrounding the stage ends up rising due to the heat generated by the stage, there is also the problem of deterioration of stage positioning accuracy due to the effects of deviations in the interferometer light path.

Therefore, cooling is carried out in the prior art by sending (circulating) a coolant to the site of heat generation while controlling the coolant temperature by a temperature controller. However, in the case of cooling the wafer stage and reticle stage, which generate considerable heat in 1/10° C. units, and the projection optics and alignment system, for which the temperature must be controlled in 1/100° C. units, using a single temperature controller, cooling capacity becomes inadequate for the wafer stage and reticle stage that demonstrate large temperature changes if the coolant temperature is controlled based on the temperature of the projection optics. Conversely, if the coolant temperature is controlled based on the temperature of the wafer stage and reticle stage, it is no longer possible to control the temperature of the projection optics and alignment system with the required level of precision (fineness). In particular, since the reticle stage moves over a distance and at a speed corresponding to the projection factor with respect to the wafer stage, the amount of heat generated is extremely large, thus making it difficult to manage the temperature of the projection optics and alignment system with the same control system. In this manner, unless temperature management is adequate, problems occur in which the baseline shift increases and overlay accuracy worsens.

### DISCLOSURE OF THE INVENTION

In consideration of the aforementioned problems, the object of the present invention is to provide an exposure system and device production process that enables the required temperature control for each component while also being able to control baseline shift.

In order to achieve the aforementioned object, the present invention employs the following constitution corresponding to FIGS. 1 through 10 showing embodiments of the present invention.

The exposure system of the present invention is an exposure system for projecting a pattern image of a reticle held on a reticle stage onto a substrate held on a substrate stage, by means of projection optics. The exposure system comprises: a first control system for setting the temperature of a first liquid and circulating the first liquid for at least one object of the projection optics and the substrate stage to control the temperature of the object; and a second control system for setting the temperature of a second liquid independent of the first control system and circulating the second liquid for the reticle stage to control the temperature of the reticle stage, wherein the first and second control systems have mutually different setting capacities with respect to the size of the temperature range when setting the temperatures of the liquids.

Thus, in the exposure system of the present invention, the temperature of the projection optics and substrate stage can be separately and independently controlled in, for example, 1/100° C. units by circulating the first liquid in the first control system, while the temperature of the reticle stage can be separately and independently controlled in, for example, 1/10° C. units by circulating the second liquid in the second control system. Namely, since the first and second control systems are individually set corresponding to the temperature range required by the projection optics and reticle stage, temperature can be controlled at the level of accuracy required by each component, thereby making it possible to inhibit baseline shift caused by temperature fluctuations.

In addition, the exposure system of the present invention is an exposure system for projecting a pattern image of a reticle held on a reticle stage onto a substrate held on a substrate stage, by means of projection optics. The exposure system comprises: a first control system for setting first circulation conditions when circulating a first liquid for at least one object of the projection optics and the substrate stage, and controlling the temperature of the object by circulating the first liquid under the first circulation conditions; a second control system for setting second circulation conditions when circulating a second liquid for the reticle stage independent of the first circulation conditions, and controlling the temperature of the reticle stage by circulating the second liquid under the second circulation conditions; a first detection unit for respectively detecting the temperature of the first liquid before circulating for the object and the temperature of the first liquid after having circulated for the object; and a second detection unit for respectively detecting the temperature of the second liquid before circulating for the reticle stage and the temperature of the second liquid after having circulated for the reticle stage, wherein the first control system sets the first circulation conditions based on the detection results of the first detection unit, and the second control system sets the second circulation conditions based on the detection results of the second detection unit.

Thus, in the exposure system of the present invention, the temperature of the projection optics and substrate stage can be respectively and independently controlled in, for example, 1/100° C. units in the first control system by circulating the first liquid under the first circulation conditions, and the temperature of the reticle stage can be respectively and independently controlled in, for example, 1/10° C. units in the second control system by circulating the second liquid under the second circulation conditions. Namely, since the first and second control systems are individually set corresponding to the temperature range required by the projection optics and reticle stage, temperature can be controlled at the level of accuracy required by each component, thereby making it possible to inhibit baseline shift caused by temperature fluctuations. At this time, since the first and second circulation conditions are set based on the temperatures of the first and second liquids that are detected before and after circulating through each component, temperature can be controlled with high precision based on temperature changes of the first and second liquids that occur as a result of circulating through each component.

The exposure system of the present invention is an exposure system for projecting a pattern image of a reticle held on a reticle stage onto a substrate held on a substrate stage, by means of projection optics, the reticle stage and substrate stage each provided with a plurality of drive sources. The exposure system comprises: a first control system for controlling temperature by setting as a first controlled system one or more of the drive sources and projection optics for which the amount of heat generation or amount of temperature change is within a first predetermined amount; and a second control system for controlling temperature independently of the first control system by setting as a second controlled system one or more of the drive sources and projection optics for which the amount of heat generation or amount of temperature change exceeds the first predetermined amount.

Thus, in the exposure system of the present invention, temperature can be respectively and independently controlled with the first control system by making the drive sources of the substrate stage and projection optics having a low amount of heat generation or temperature change first control targets, and temperature can be respectively and independently controlled with the second control system by making the drive sources of the reticle stage having a comparatively large amount of heat generation or temperature change second control targets. Namely, since the projection optics and stage drive sources are made to be control targets corresponding to the amount of heat generated or temperature change, temperature can be controlled at the level of accuracy required by each component, thereby making it possible to inhibit baseline shift caused by temperature fluctuations.

In addition, the device production process of the present invention is comprised of a step in which a pattern formed on a reticle is transferred onto a substrate using an exposure system according to any of claims 1 through 26.

Thus, in the device production process of the present invention, a pattern can be transferred to a substrate in a state in which the required temperature control has been carried out, thereby making it possible to obtain a device having superior overlay accuracy by inhibiting baseline shift caused by temperature fluctuations.

### BRIEF DESCRIPTION OF THE DRAWINGS

FIG. 1 is a schematic block diagram of an exposure system of the present invention.

FIG. 2 is a perspective view of the appearance of a reticle stage that composes the same exposure apparatus.

FIG. 3 is a perspective view of the appearance of a wafer stage that composes the same exposure system.

FIG. 4 is a drawing showing a temperature control system pertaining to the entire exposure system in a first embodiment.

FIG. 5 is a drawing showing a temperature control system pertaining to a reticle stage.

FIG. 6 is a drawing showing a temperature control system pertaining to a wafer stage.

FIG. 7 is a flow chart showing an example of a semiconductor device production process.

FIG. 8 is a drawing schematically showing a temperature control system for the entire exposure system in a second embodiment.

FIG. 9 is a drawing schematically showing a temperature control system for the entire exposure system in a third embodiment.

FIG. 10 is a drawing schematically showing a temperature control system for a reticle stage in a fourth embodiment.

FIGS. 11A through 11C are drawings showing variations of the present invention.

### BEST MODE FOR CARRYING OUT THE INVENTION

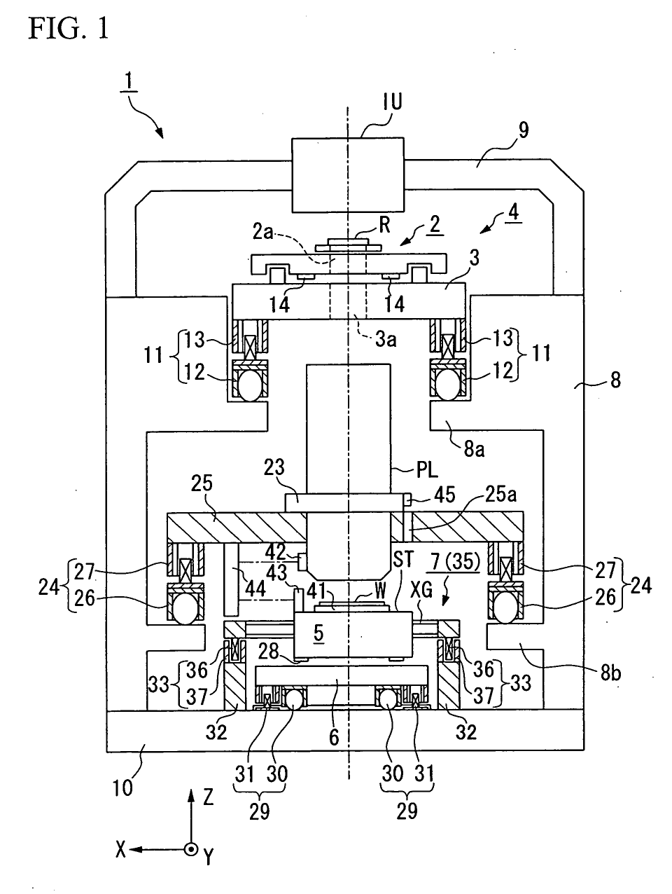

The following provides an explanation of a first embodiment of an exposure system and device production process of the present invention with reference to FIGS. 1 through 7. Here, an explanation is provided using the example of the case of using a scanning stepper for the exposure system that transfers a circuit pattern of a semiconductor device formed on reticle to a wafer while synchronously rotating the reticle and wafer during exposure (during pattern transfer).

Exposure system 1 shown in FIG. 1 is roughly composed of illumination optics IU, which illuminates a rectangular (or arc-shaped) illumination region at uniform luminosity on reticle (mask) R with illumination light for exposure from a light source (not shown), a stage system 4, which includes a reticle stage (mask stage) 2 that moves while holding reticle R and a reticle surface plate 3 that supports said reticle stage 2, projection optics PL, which projects illumination light emerging from reticle R onto wafer (substrate) W, a stage system 7, which includes a wafer stage (substrate stage) 5 that moves while holding a sample in the form of a wafer W and a wafer surface plate 6 that holds said wafer stage 5, and a reaction frame 8 that supports the aforementioned stage system 4 and projection optics (projection optical system) PL. Furthermore, the direction of the optical axis of projection optics PL is designated as the Z direction, the direction perpendicular to the Z direction in which reticle R and wafer W move synchronously is designated as the Y direction, and the direction of non-synchronous movement is designated as the X direction. In addition, the directions of rotation around each axis are designated as θZ, θY and θX, respectively.

Illumination optics IU is supported by a support column 9 fastened to the upper surface of reaction frame 8. Furthermore, examples of light used for the illumination light for exposure include deep ultraviolet light (DUV light) such as the emission lines (g lines, i lines) of the ultraviolet region emitted from an ultra-high-pressure mercury lamp or KrF excimer laser light (wavelength: 248 nm), and vacuum ultraviolet light (VUV light) such as ArF excimer laser light (wavelength: 193 nm) and F₂ laser light (wavelength: 157 nm).

Reaction frame 8 is installed on a base plate 10 placed horizontally on a floor surface, and ledges 8a and 8b are respectively formed protruding inward in its upper and lower sections.

Within stage system 4, reticle surface plate 3 is supported nearly horizontally by means of vibration isolation units 11 by ledge section 8a of reaction frame 8 at each corner (the vibration isolation units in the back are not shown), and an opening 3a through which the pattern image formed on reticle R passes is formed in the center. Furthermore, metal or ceramics can be used for the material of reticle surface plate 3. Vibration isolation units 11 are composed such that air mounts 12, for which internal pressure can be adjusted, and voice coil motors 13 are arranged in a row on ledge 8a. These vibration isolation units 11 allow micro-vibrations transmitted to reticle surface plate 3 via base plate 10 and reaction frame 8 to be insulated at the micro G level (G indicates the gravitational acceleration).

Reticle stage 2 is supported on reticle surface plate 3 while able to move two-dimensionally along said reticle surface plate 3. A plurality of air bearings (air pads) 14 are fastened to the bottom surface of reticle stage 2, and reticle stage 2 is supported while floating on reticle surface plate 3 at a clearance on the order of several microns by these air bearings 14. In addition, an opening 2a through which the pattern image of reticle R passes is formed in the center of reticle stage 2 that communicates with opening 3a of reticle surface plate 3.

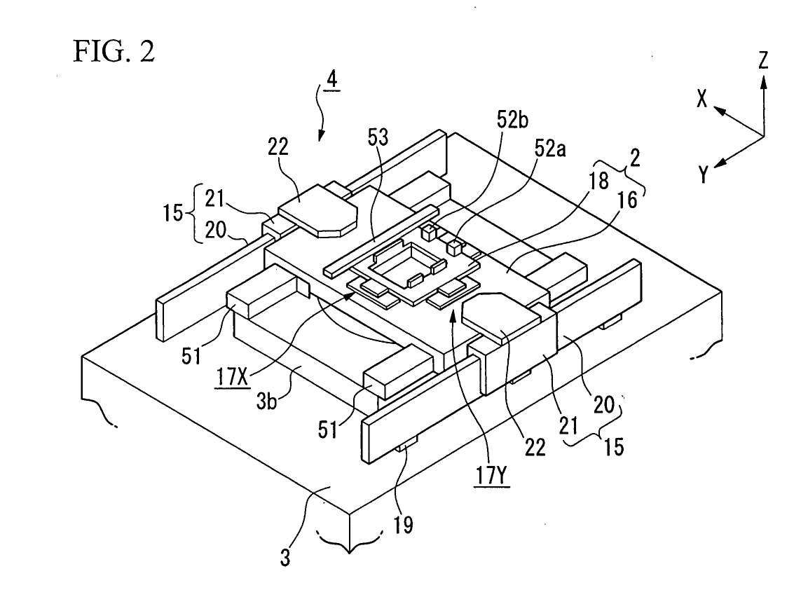

The following provides a detailed description of reticle stage 2. As shown in FIG. 2, reticle stage 2 is composed of a reticle coarse movement stage 16, which is driven at a predetermined stroke in the direction of the Y axis by a pair of Y linear motors (drive sources) 15 on reticulate surface plate 3, and a reticle fine movement stage 18, which is finely driven in the X, Y and θZ directions by a pair of X voice coil motors (drive sources) 17X and a pair of Y voice coil motors (drive sources) 17Y on reticle coarse movement stage 16. (Furthermore, these are shown as a single stage in FIG. 1).

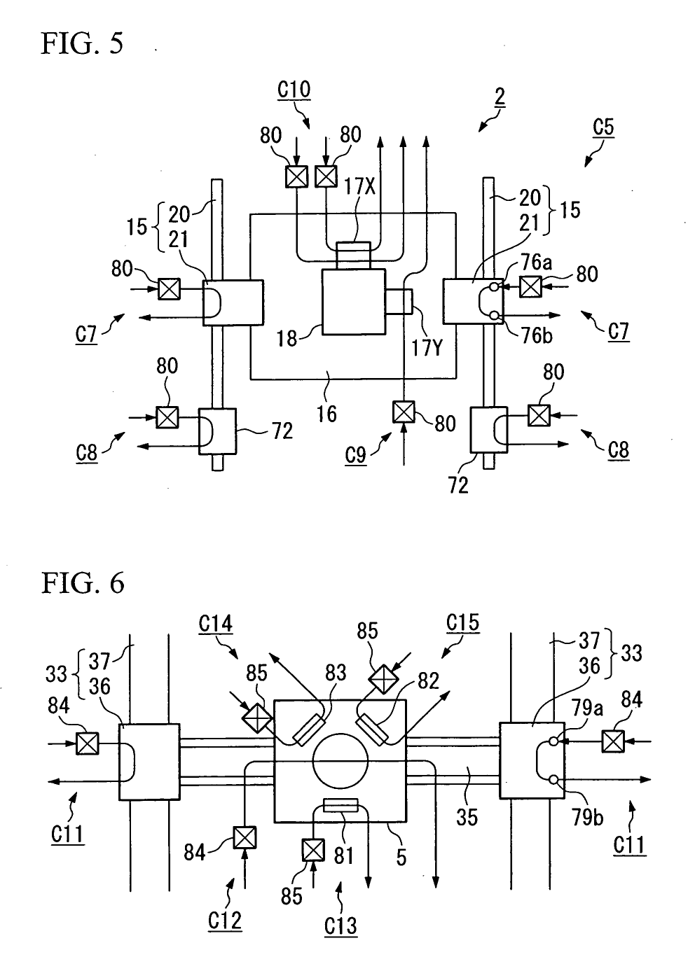

Each Y linear motor 15 is composed of stators 20, which are supported while floating by non-contact bearings in the form of a plurality of air bearings (air pads) 19 on reticle surface plate 3 and extend in the Y direction, and movers 21, which are provided corresponding to these stators 20 and are fastened to reticle coarse movement stage 16 by means of coupling members 22. Consequently, stators 20 move in the −Y direction in the form of a counter mass corresponding to movement in the +Y direction by reticle coarse movement stage 16 in accordance with the law of conservation of parity. Together with being able to offset reactionary force accompanying movement of reticle coarse movement stage 16 due to movement of these stators 20, changes in the location of the center of gravity can also be prevented. Furthermore, since movers 21 and stators 20 are coupled in each Y linear motor 15, during their relative movement, a force acts that attempts to stop them at their original positions. Consequently, in the present embodiment, a trim motor 72 (drive source: not shown in FIG. 2, refer to FIG. 5) is provided that corrects the amount of movement so that stators 20 reach their predetermined positions.

Reticle coarse movement stage 16 is guided in the direction of the Y axis by a pair of Y guides 51 that are fastened to the upper surface of an upper projection 3b formed in the center of reticle surface plate 3 and extend in the direction of the Y axis. In addition, reticle coarse movement stage 16 is supported in a non-contact manner by air bearings not shown with respect to these Y guides 51.

Reticle R is suctioned and held to reticle fine movement stage 18 by means of a vacuum chuck not shown. A pair of Y moving mirrors 52a and 52b composed of corner cubes are fastened to one end in the −Y direction of reticle fine movement stage 18, and an X moving mirror 53 composed of a flat mirror extending in the direction of the Y axis is fastened to the end in the +X direction of reticle fine movement stage 18. As a result of three laser interferometers (none are shown) that radiate a measuring beam onto moving mirrors 52a, 52b and 53 measuring the distance to each moving mirror, the positions in the X, Y and θZ directions (rotation around the Z axis) of reticle stage 2 can be measured with high precision.

Returning to FIG. 1, a dioptric system having circular projection field in which both the object surface (reticle R) side and image surface (wafer W) side are telecentric, and having a reduction rate of ¼ (or ⅕) composed of a dioptric element (lens element) that uses quartz or quartzite for the optical quencher, is used for the projection optics PL. Consequently, when illumination light is radiated onto reticle R, imaging light from the portion of the circuit pattern on reticle R that is illuminated with the illumination light enters projection optics PL, and a partially inverted image of the circuit pattern is formed restricted to a slit shape in the center of the circular field on the image surface side of projection optics PL. As a result, the projected partially inverted image of the circuit pattern is reduced and transferred to the resist layer of one of the shot region surfaces of the plurality of shot regions on wafer W arranged on the imaging surface of projection optics PL. A flange 23 is integrally provided with the barrel of projection optics PL on the outer periphery of that barrel. Projection optics PL is inserted from above with the direction of the optical axis in the Z direction into barrel surface plate 25 composed of a casting and so forth supported nearly horizontally by means of vibration isolation units 24 on ledge 8b of reaction frame 8, and engages with flange 23.

Vibration isolation units 24 are arranged in each corner of barrel surface plate 25 (the vibration isolation units in the back are not shown), and are composed of an air mount 26, for which internal pressure can be adjusted, and a voice coil motor 27 arranged in a row on ledge 8b. These vibration isolation units 24 allow micro-vibrations transmitted to barrel surface plate 25 (and eventually to projection optics PL) via base plate 10 and reaction frame 8 to be insulated at the micro G level.

Stage system 7 is primarily composed of wafer stage 5, wafer surface plate 6, which movably supports wafer stage 5 two-dimensionally along the XY plane, sample tray ST, which suctions and holds wafer W integrally provided with wafer stage 5, and X guide bar XG that supports wafer stage 5 and sample tray ST while allowing their relative movement. A plurality of non-contact bearings in the form of air bearings (air pads) 28 are fastened to the bottom surface of wafer stage 5, and wafer stage 5 is supported while floating at a clearance on the order of several microns, for example, on wafer surface plate 6 by these air bearings 28.

Wafer surface plate 6 is supported nearly horizontally by means of vibration isolation units 29 above base plate 10. Vibration isolation units 29 are arranged in each corner of wafer surface plate 6 (the vibration isolation units in the back are not shown), and are composed of an air mount 30, for which internal pressure can be adjusted, and a voice coil motor 31 arranged in a row on base plate 10. These vibration isolation units 29 allow micro-vibrations transmitted to wafer surface plate 6 via base plate 10 to be insulated at the micro G level.

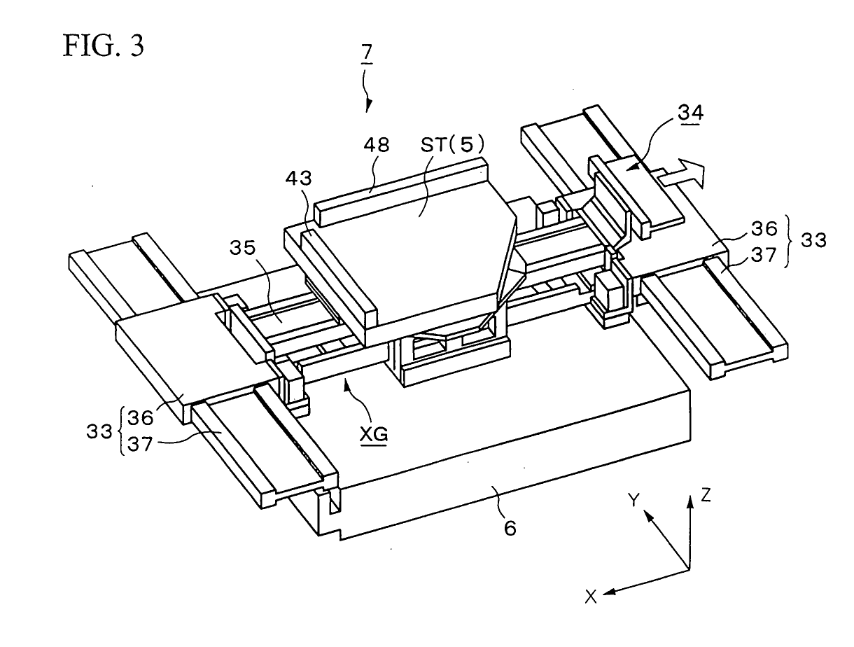

As shown in FIG. 3, X guide bar XG has a long shape along the X direction, and movers 36 composed of armatures are respectively provided on both ends in its lengthwise direction. Stators 37 having magnet units corresponding to these movers 36 are provided on supports 32 providing protruding from base plate 10. (See FIG. 1. Furthermore, movers 36 and stators 37 are omitted from FIG. 1.) Moving coil type linear motors (drive sources) 33 are composed by these movers 36 and stators 37, and as a result of movers 36 being driven by the electromagnetic interaction with stators 37, together with X guide bar XG moving in the Y direction, it also rotates in the OZ direction by adjusting the driving of linear motors 33. Namely, wafer stage 5 (as well as sample tray ST, which is to simply be referred to as sample stage ST) is driven in the Y direction and θZ direction nearly integrally with X guide bar XG by this linear motor 33.

In addition, a mover of X trim motor 34 is attached on the side of X guide bar XG in the −X direction. As a result of generating thrust in the X direction, X trim motor 34 adjusts the position in the X direction of X guide bar XG, and its stator (not shown) is provided on reaction frame 8. Consequently, reactionary force when wafer stage 5 is driven in the X direction is transmitted to base plate 10 through reaction frame 8.

Sample tray ST is supported and held in a non-contact manner on X guide bar XG while allowing to move relatively in the X direction by means of a magnetic guide composed of a magnet and actuator that maintains a predetermined gap in the Z direction with X guide bar XG In addition, wafer stage 5 is driven in the X direction by electromagnetic interaction by X linear motor (drive source) 35 having a stator embedded in X guide bar XG Furthermore, although the mover of X linear motor 35 is not shown, it is attached to wafer stage 5. Wafer W is immobilized on the upper surface of sample tray ST by vacuum suction and so forth by means of wafer holder 41 (see FIG. 1, not shown in FIG. 3).

The position of wafer stage 5 in the X direction is measured on a real-time basis at a predetermined resolution of, for example, about 0.5 to 1 nm by a laser interferometer 44 that measures the change in position of a moving mirror 43 fastened to a portion of wafer stage 5 using a reference mirror 42 fastened to the lower end of the barrel of the projection optics PL as a reference. Furthermore, the position of wafer stage 5 in the Y direction is measured by a reference mirror, laser interferometer and moving mirror not shown arranged so as to be nearly perpendicular to the aforementioned reference mirror 42, moving mirror 43 and laser interferometer 44. Furthermore, at least one of these laser interferometers is a multi-axis interferometer having two more measuring axes, and in addition to the XY position of wafer stage 5 (as in turn wafer W), the amount of θ rotation or the amount of leveling in addition to this, can be determined based on the measured values of these laser interferometers.

Moreover, three laser interferometers 45 are fastened at three different locations on flange 23 of projection optics PL (however, only one representative laser interferometer of these laser interferometers is shown in FIG. 1). An opening 25a is respectively formed in the portion of barrel surface plate 25 in opposition to each laser interferometer 45, and a laser beam (measuring beam) is radiated towards wafer surface plate 6 in the Z direction from each laser interferometer 45 through these openings 25a. Reflecting surfaces are respectively formed at the opposing positions of each measuring beam on the upper surface of wafer surface plate 6. Consequently, the Z positions of three different points of wafer surface plate 6 are respectively measured based on flange 23 by the aforementioned three laser interferometers 45.

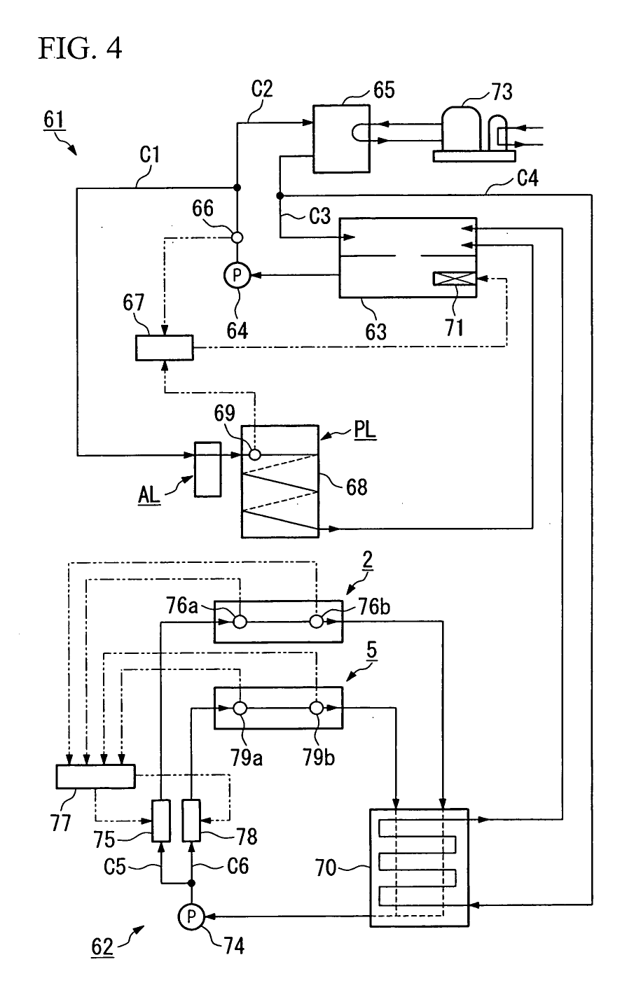

Next, an explanation is provided of the temperature control system in exposure system 1 using FIGS. 4 through 6.

FIG. 4 shows a temperature control system for the entire exposure system, FIG. 5 shows a temperature control system for the reticle stage 2, and FIG. 6 shows a temperature control system for the wafer stage 5. Furthermore, although HFE (hydrofluoroether) or Fluorinert can be used for the medium (coolant) for regulating temperature, HFE is used in the present embodiment from the viewpoint of protecting the global environment since the global warming potential is low and the ozone-depleting potential is zero.

This temperature control system can be broadly divided into a first control system 61, which controls and manages temperature with the projection optics PL and alignment system AL serving as the first temperature control targets using a coolant for the first liquid, and a second control system 62, which controls and manages temperature independent from first control system 61 with the reticle stage 2 and wafer stage 5 serving as the second control targets using a coolant for the second liquid. Furthermore, in this temperature control system, the projection optics PL and alignment system AL, for which the amount of generated heat (amount of temperature change) is within a predetermined amount (first predetermined amount), is designated are designated as the first temperature control targets, while the reticle stage 2 and wafer stage 5, for which the amount of generated heat is larger than the aforementioned predetermined amount, are designated as second temperature control targets.

Coolant in tank 63 for which temperature is regulated in first control system 61 is branched into circulation system C1, in which it sequentially circulates through alignment system AL and projection optics PL after passing through pump 64, and cooling system C2, in which it is cooled with evaporator 65. The coolant temperature immediately after being discharged from pump 64 is detected with a sensor 66 and output to a controller 67.

With respect to circulation system C1, temperature regulation by coolant is set to a wide range as a result of arranging projection optics PL in a spiral shape around barrel 68. In the present embodiment, although the coolant is composed to as to circulate from top to bottom through a line arranged in a spiral shape around barrel 68 as shown in FIG. 4, the present invention is not limited to this, but rather may also be composed so that the coolant circulates from bottom to top in a spiral shape. In addition, in this circulation system C1, a sensor 69 is provided that detects the coolant temperature prior to circulating through projection optics PL, and the detected result is output to controller 67. Furthermore, although the temperature of projection optics PL is regulated by arranging a line in a spiral shape over nearly the entire surface around barrel 68 as previously described in the present embodiment, the present invention is not limited to this, but rather a line may be arranged in a portion of a member (flange 23) that holds projection optics PL to regulate temperature by employing a so-called flange temperature regulation system.

Although examples of off-axis types of alignment systems AL that can be employed include a laser step alignment (LSA) system, in which He-Ne or other laser light is radiated onto alignment marks in the form of rows of dots on wafer W and then detecting the positions of the marks using light that has been refracted or scattered by the marks, a field image alignment (FIA) system, in which image data of alignment marks illuminated with light having a wide wavelength band using a halogen lamp and so forth for the light source and photographed with a CCD camera and so forth is processed to measure the positions of the marks, or a laser interferometric alignment (LIA) system, in which two coherent beams (such as from a semiconductor laser) inclined in contrast in the direction of pitch are radiated onto alignment marks in the form of a diffraction grating on a wafer W followed by causing interference between the two types of refracted light that are generated and measuring the positions of the alignment marks from their phases, an LSA system is used here, and in circulation system C1, coolant is circulated through alignment system AL for the alignment light source to regulate temperature. A line arranged in a spiral shape in a case that encloses the light source can be used for the circulation system in the same manner as projection optics PL, for example.

Furthermore, in alignment system AL, a constitution may also be employed in which temperature is regulated by also circulating coolant through a case that encloses not only the alignment light source but also the alignment optics. In addition, temperature can also be regulated by similarly circulating coolant through an alignment light source and case in a TTR (Through The Reticle) system or TTL (Through The Lens) system, in which marks on a wafer W are detected by means of the projection optics PL, instead of an off-axis system.

The coolant that circulates through alignment system AL and projection optics PL in circulation system C1 flows into an upper chamber of tank 63 that is divided while communicating between two upper and lower levels.

On the other hand, the coolant of circulation system C2 is branched into path C3, in which coolant flows into an upper chamber of tank 63 after being cooled with evaporator 65, and path C4, in which coolant flows towards a heat exchanger 70. Furthermore, evaporator 65 is cooled by a refrigerator 73 through which a gaseous coolant is circulated. The cooled coolant is cooled by again flowing to the upper chamber of tank 63 after being used for heat exchange in heat exchanger 70 in path C4.

A heater 71 controlled by controller 67 is arranged in the lower chamber of tank 63, and as a result of controller 67 controlling the driving of heater 71 based on detection results of sensors 66 and 69, the temperature of alignment system AL and projection optics PL is controlled (managed) to, for example, 23±0.01° C. by means of the coolant. Furthermore, first control system 61 allows coolant for which temperature has been regulated with the aforementioned heater 71 to circulate in equal amounts at a time to each temperature control target.

In the second control system 62, coolant in the form of a second coolant cooled with heat exchanger 70 is branched to a circulation system C5, in which coolant circulates through reticle stage 2, and a circulation system C6, in which coolant circulates through wafer stage 5, after passing through pump 74. Furthermore, the coolant in system control system 62 employs a constitution in which it circulates in a closed system without flowing to tank 63.

Together with a heater 75 being provided at a position downstream from pump 74, sensors 76a and 76b (second detection unit) are provided in circulation system C5 that respectively detect the coolant temperature before circulating to reticle stage 2 and the coolant temperature after having circulated through reticle stage 2, and the detection results of sensors 76a and 76b are output to controller 77. As a result of controller 77 determining the simple average of the input detection results of sensors 76a and 76b and controlling the driving of heater 75 based on the resulting coolant temperature, it controls (manages) the temperature of reticle stage 2 to, for example, 23±0.01° C.

Furthermore, although the present embodiment is composed such that coolant cooled with heat exchanger 70 is circulated to pump 74, in the case the pressure loss of heat exchanger 70 is large, it should be composed such that pump 74 is arranged farther upstream than heat exchanger 70, and the location where the coolant that returns to circulation systems C5 and C6 converges (coolant after circulating through each stage 2 and 5) is located farther upstream than pump 74.

The aforementioned temperature sensors 76a and 76b are preferably both arranged as close as possible to the temperature control targets (reticle stage 2, and more precisely, a motor that drives reticle stage 2 to be described later). However, in the case the sensors cannot be arranged near the temperature control targets such as due to restrictions on their arrangement or due to the magnetic effects of the motor, they can be provided at locations somewhat removed from the temperature control targets provided they are within a range (location) not affected by heat from the outside.

In addition, although it is desirable that the interval between each sensor and the temperature control target be nearly equal such that the control target is arranged at roughly the same interval between both sensors (i.e., the interval between sensor 76a and reticle stage 2 and the interval between sensor 76b and reticle stage 2 are nearly equal), the arrangement of each sensor is not limited to this provided it is within the previously described range (within a range that that is not affected by heat from the outside).

The following provides a more detailed description of the temperature control system for reticle stage 2.

As shown in FIG. 5, circulation system C5 is branched into a plurality of branching flow paths consisting of circulation systems C7, which control temperature by circulating coolant through each mover 21, respectively, of Y linear motor 15, circulation systems C8, which control temperature by circulating coolant through each trim motor 72, respectively, circulation system C9, which controls temperature by circulating coolant through Y voice coil motor 17Y, and circulation system C10, which controls temperature by circulating coolant through X voice coil motor 17X.

A valve (regulating unit) 80 is respectively provided in each circulation system C7 through C10 located upstream from each motor that regulates the flow volume of coolant. In addition, a temperature sensor (first temperature detection unit) 76a, which detects coolant temperature before circulating through movers 21, and a temperature sensor (second temperature detection unit) 76b, which detects coolant temperature after having circulated through movers 21, are provided near movers 21 in one of the circulation systems C7.

Together with a heater 78 being provided located downstream from pump 74, temperature sensors (first detection unit) 79a and 79b are provided in circulation system C6 which respectively detect coolant temperature before circulating through wafer stage 5 and coolant temperature after having circulated through wafer stage 5, and the detection results of temperature sensors 79a and 79b are output to controller 77. Controller 77 averages the input detection results of temperature sensors 79a and 79b, and as a result of controlling driving of heater 78 based on the resulting coolant temperature, controls (manages) the temperature of wafer stage 5 to, for example, 23±0.1° C. The coolant that has circulated through stages 2 and 5 in circulation systems C5 and C6 converges after being cooled with heat exchanger 70.

The locations where the aforementioned temperature sensors 79a and 79b are arranged are similar to the case of the aforementioned sensors 76a and 76b in that it is desirable that both sensors be arranged as close as possible to the temperature control targets (wafer stage 5, and more precisely, a motor that drives wafer stage 5 to be described later). However, in the case the sensors cannot be arranged near the temperature control targets such as due to restrictions on their arrangement or due to the magnetic effects of the motor, they can be provided at locations somewhat removed from the temperature control targets provided they are within a range (location) not affected by heat from the outside.

A description of the locations where sensors 79a and 79b are arranged is omitted here since they are the same as the arrangement of sensors 76a and 76b previously described.

Continuing, a more detailed description is provided of the temperature control system for wafer stage 5.

As shown in FIG. 6, circulation system C6 is branched into circulation systems C11, which control temperature by respectively circulating coolant through movers 36 of linear motor 33, and circulation system C12, which controls temperature by circulating coolant through X linear motor 35. A valve 84 that is located upstream from each motor and regulates the flow volume of coolant is respectively provided in each circulation system C11 through C12. In addition, the aforementioned sensors 79a and 79b are provided in one circulation system C11 for respectively detecting coolant temperature before circulating through movers 36 and detecting coolant temperature after having circulated through movers 36.

Furthermore, circulation systems C13 through C15 are arranged for three voice coil motors 81 through 83 for performing leveling adjustment (and focus adjustment) of wafer stage 5 (sample tray ST), and although a valve 85 located upstream from the motor which regulates coolant flow volume is respectively provided in each circulation system, since the driving frequencies of voice coil motors 81 through 83 are lower as compared with linear motors 33 and 35, and the amount of heat generated during driving is also lower, the temperatures of these circulation systems C13 through C15 is controlled with coolant that has been diverted from circulation system C1 of control system 61. The temperature of a circulation system that manages the temperature of a motor that generates a low amount of heat during driving (e.g., the aforementioned trim motor 72 and X voice coil motor 17X), without limiting to these voice coil motors 81 through 83, may also be controlled with a coolant that has been diverted from circulation system C1 of first control system 61.

Furthermore, although temperature sensors capable of detecting at a level of precision of ±0.1° C. are used in the present embodiment for the aforementioned temperature sensors 66, 69, 76a, 76b, 79a and 79b, since the temperature control accuracy required for reticle stage 2 and wafer stage 5 in the second control system 62 is ±0.1° C., temperature sensors having a detection capability corresponding to this level of accuracy can also be used for temperature sensors 76a, 76b, 79a and 79b. In addition, with respect to the temperature measurement sampling intervals of the temperature sensors as well, in the case of severe requirements on control accuracy or large changes in temperature, the temperature measurement sampling intervals are also preferably changed, such as by shortening the sampling interval, corresponding to the required temperature control accuracy or amount of the temperature change (amount of heat generated) of the control targets in the form of projection optics PL and stages 2 and 5.

In addition, with respect to the arrangement of each temperature sensor, although the sensors are installed the flow path (line) so as to be able to measure coolant temperature directly in the present embodiment, a constitution can also be employed in which the sensors are arranged at locations where the detecting section of the temperature sensors is removed from the wall surface of the line (state in which the detecting section is suspended near the center of a cross-section of the line). In this case, since the detecting section of the sensor does not make contact with the line wall, it is less susceptible to the detrimental effects of the external environment via the wall surface of the line. In addition, a constitution may also be employed in which the temperature sensors can be replaced. In this case, a constitution can be employed in which an insertion hole is provided in a line, and the sensor can be installed and removed through this insertion hole, or a constitution can be employed in which a temperature sensor is fastened to the line by welding and so forth, and the portion of the line that contains the temperature sensor can be replaced. Moreover, a constitution can also be employed in which a temperature sensor is installed on the outer surface of a line, and coolant temperature is measured by means of the line.

In an exposure system 1 having the aforementioned constitution, a predetermined rectangular illumination region on reticle R is illuminated at uniform luminosity by illumination light for exposure from illumination optics IU during exposure. Synchronous to reticle R being scanned in the Y direction for this illumination region, wafer W is scanned for a conjugate illumination region with respect to this illumination region and projection optics PL. As a result, illumination light that has passed through a pattern region on reticle R is reduced by a factor of ¼ by projection optics PL, and radiated onto wafer W coated with a resist. The pattern of reticle R is then successively transferred to the exposure region on wafer W, and the entire pattern region on reticle R is transferred to the shot region of wafer W in a single scan.

Since stators 20 move in the −Y direction in the case reticle coarse movement stage 16 has moved in the +Y direction, for example, the amount of movement is conserved, which together with offsetting the reactionary force accompanying movement of reticle coarse movement stage 16, is able to prevent changes in the location of the center of gravity. In addition, since trim motor 72 operates at this time, stators 20 are able to reach a predetermined position in opposition to the coupling of movers 21 and stators 20.

With respect to this series of exposure processing, together with heat being generated in projection optics PL due to the illumination light (heat absorption in projection optics PL due to radiation of illumination light) and heat being generated in alignment system AL due to the alignment light (heat absorption in the alignment system due to radiation of alignment light), heat is also generated from each motor accompanying driving of stages 2 and 5. With respect to the first control system 61, as a result of controller 67 controlling the driving of heater 71 by setting the conditions during circulation of coolant (first circulation conditions) based on the detection results of temperature sensors 66, the temperature of projection optics PL and alignment system AL is controlled to within a range of ±0.01° C. In addition, with respect to the second control system 62, as a result of controller 77 controlling the driving of heaters 75 and 78 by setting conditions during circulation of coolant (second circulation conditions) based on the detection results of temperature sensors 76a, 76b, 79a and 79b, the temperature of reticle stage 2 and wafer stage 5 can be controlled to within a range of ±0.1° C.

In providing a more detailed description of this, first with respect to reticle stage 2, controller 77 determines the simple average of the coolant temperatures detected by temperature sensors 76a and 76b, and then regulates and manages the driving of heater 75 as the first temperature management section based on the resulting coolant temperature. Here, temperature sensors 76a and 76b are provided in circulation system C7, which circulates coolant through movers 21 of Y linear motor 15 having the largest amount of driving and the largest amount of heat generation, while temperature is controlled for the other circulation systems C8 through C10 based on circulation system C7. Consequently, in the present embodiment, the correlation between the process and optimum coolant flow volume is determined in advance and stored in memory through experimentation and simulation and so forth, and valves 80 of each circulation system C7 through C10 are adjusted for each process based on that stored information.

Here, examples of heat generation factors to be taken into consideration by the process include the various driving states in each motor 15, 17X, 17Y and 72, namely the amount of driving, speed and rotating speed of each motor along with status in the case of driving in combination with other motors. Thus, by adjusting valves 80 so that the coolant flow volume is decreased for voice coil motors 17X and 17Y that generate a small amount of heat (or small amount of driving) in the process, while the coolant flow volume is increased for Y linear motor 15 and trim motor 72 having that generate a large amount of heat (or amount of movement), it is possible to control the temperature to the proper temperature corresponding to the output (heat generation) of each motor. Furthermore, the method for adjusting valves 80 may be a method in which workers adjust the valves for each process based on stored information, or a method in which controller 77 adjusts the driving mechanism for each process based on stored information. Furthermore, the target of this adjustment for each process is not limited to flow volume, but rather the settings for coolant temperature (temperature set by the heater) can also be changed for each process.

Similarly, with respect to wafer stage 5, controller 77 determines the simple average for the coolant temperatures detected by temperature sensors 79a and 79b, and then regulates and manages the driving of heater 78 as a second temperature management section based on the resulting coolant temperature. Here, temperature sensors 79a and 79b are provided in circulation system C11, which circulates coolant through movers 36 of Y linear motor 33 having the largest amount of driving and the largest amount of heat generation, while temperature is controlled for the other circulation system C12 based on circulation system C11. Consequently, in the present embodiment, the correlation between the process and optimum coolant flow volume is determined in advance and stored in memory through experimentation and simulation and so forth, and valves 85 of each circulation system C11 and C12 are adjusted for each process based on that stored information. Valves 85 may be adjusted manually or automatically in the same manner as in the case of reticle stage 2.

Furthermore, although the temperatures of voice coil motors 81 through 83 provided in wafer stage 5 are controlled by circulation systems C13 through C15 of first control system 61 since the amount of heat generated is extremely small, in this case as well, the correlation between the process and optimum coolant flow volume is determined in advance through experimentation and simulation and then stored in memory, and valves 85 of each circulation system C13 through C15 are used to adjust flow volume either by manual adjustment by a worker or by automatic adjustment by controller 67 for each process.

In this manner, since first control system 61 and second control system 62 have different setting capacities within the temperature ranges during setting of coolant temperature in the present embodiment, they are capable of respectively and independently controlling and managing temperature for projection optics PL and stages 2 and 5 having different levels of required temperature control accuracy, and the optimum coolant conditions can be set corresponding to the amount of heat generated by each piece of equipment. Consequently, worsening of overlay accuracy can be prevented by inhibiting baseline shift that occurs when temperature is not adequately controlled.

In addition, in the present embodiment, since coolant temperature is not measured for all the motors but only for the motor that generates the largest amount of heat in reticle stage 2 and wafer stage 5, and the temperatures of the circulation systems for the other motors are then controlled based on that coolant temperature, it is not necessary to provide temperature sensors for each motor, thereby realizing simplification of the system and lower costs.

However, since the temperature of coolant flowing to each of the aforementioned motors respectively provided in reticle stage 2 and wafer stage 5 is controlled and managed by the same second control system 62, although the inlet temperature of the coolant for each motor (coolant temperature before circulating through each motor) is at the same temperature regardless of the motor, the outlet temperature of the coolant for each motor (coolant temperature after having circulated through each motor) differs for each motor corresponding to the degree of heat generated by each motor. Consequently, in order to make the average temperature of coolant that circulates through each motor (average temperature of coolant at the inlet and outlet of each motor) a predetermined desired value for any of the motors, it is necessary to control the coolant temperature at the outlet of each motor so as to be a predetermined value for any of the motors. Therefore, in order to realize even more accurate temperature control, a constitution may be employed in which a temperature sensor that measures coolant temperature at least at the outlet of each motor (outlet temperature sensor) is provided (while only one temperature sensor that measures inlet temperature is provided for the motor typically generating the largest amount of heat), and the flow volume of coolant that circulates to each motor is adjusted with valves corresponding to each individual motor so that the coolant outlet temperature in each motor reaches a predetermined value. When setting this flow volume, the flow volume of coolant that circulates through each motor is preferably set so that the aforementioned outlet temperature reaches a predetermined value in a state in which the stage is driven (operated) in advance under as severe exposure conditions as possible (e.g., large number of exposure shots and frequent stage movement), or in a state in which the stage is operated under typically used exposure conditions (stage driving state).

Furthermore, if permissible in terms of space and costs, a temperature sensor that measures the coolant temperature at the inlet side of the motor may also be installed for each motor.

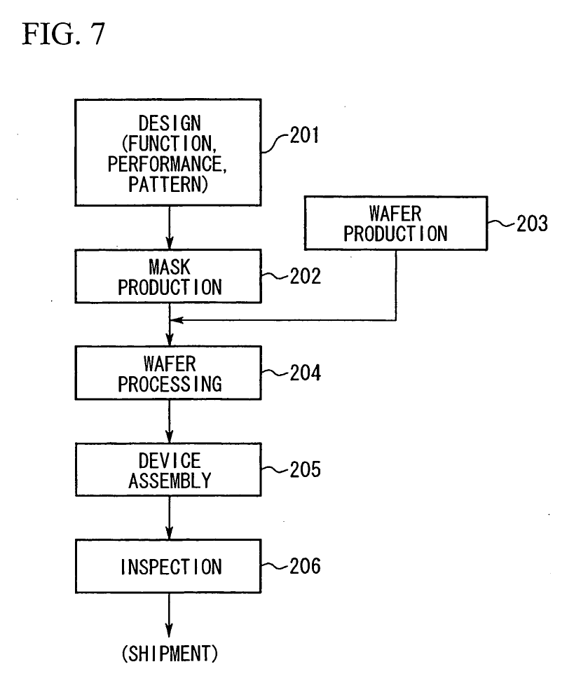

Furthermore, as shown in FIG. 7, a microdevice such as a semiconductor device is produced by going through a step 201 in which the functions and performance of the microdevice are designed, a step 202 in which a reticle R is fabricated based on this design step, a step 203 in which a wafer W is produced from a silicon material, a step 204 in which the pattern of reticle R is projected and exposed on wafer W by a projection and exposure system 1 of the previously described embodiment, a device assembly step 205 (including a dicing step, bonding step and packaging step), and an inspection step 206.

In addition, although a constitution is employed in the aforementioned embodiment in which the correlation between the process and optimum coolant flow volumes is determined and stored in memory in advance, and valves of each circulation system are adjusted for each process based on that stored information, in addition to this method, a method may also be employed in which, for example, temperature sensors are provided for each of a plurality of motors, a calculation unit is provided that calculates the ratio of the amounts of generated heat among the plurality of motors, and the flow volume of coolant that circulates through the motors is regulated corresponding to the ratio of the amounts of heat generated as calculated based on the detected coolant temperatures.

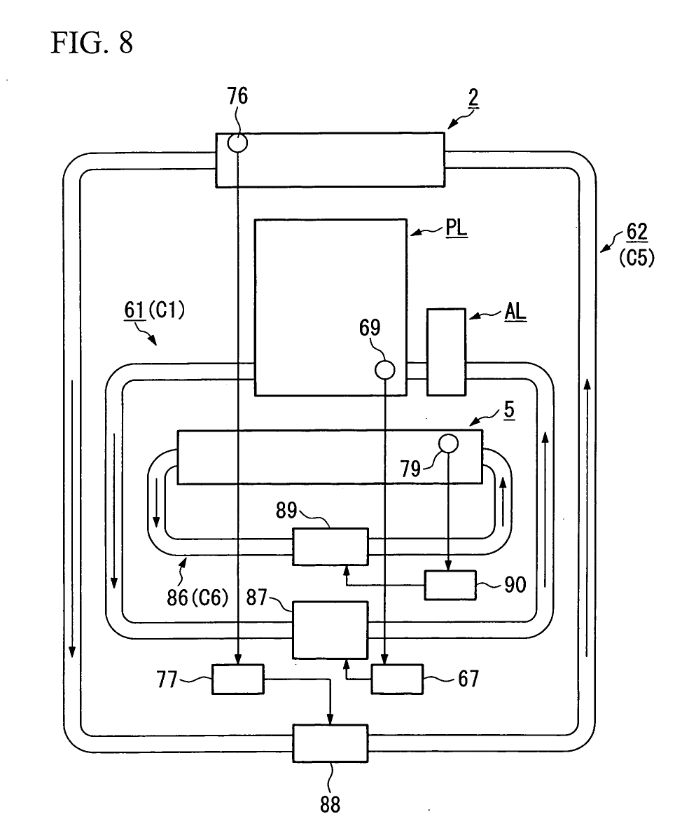

FIG. 8 is a drawing showing a second embodiment of an exposure system of the present invention. In this drawing, the same reference symbols are used to indicate those features that are identical to the constituent features of the first embodiment as shown in FIGS. 1 through 7, and their explanations and indications in the drawing are omitted.

As shown in this drawing, the projection optics and alignment system (as well as the previously described leveling adjustment system of wafer stage 5) are designated as temperature control targets of circulation system C1 by first control system 61, reticle stage 2 is designated as the temperature control target of circulation system C5 by second control system 62, and wafer stage 5 is designated as the temperature control target of circulation system C6 by a third control system 86 provided independently from first and second control systems 61 and 62. Furthermore, in FIG. 8, components having the same functions as evaporator 65 and heater 71 shown in FIG. 4 are simplified in the form of a temperature regulator 87. Similarly, components having the same functions as heat exchanger 70 and heaters 75 and 78 shown in FIG. 4 are shown in a simplified form in the form of temperature regulators 88 and 89. In addition, although two temperature sensors 76a and 76b as well as 79a and 79b each are arranged for stages 2 and 5 in FIG. 4, these are shown in FIG. 8 in the form of representative temperatures 76 and 79.

With respect to these temperature sensors 76 and 79, the motor generating the largest amount of heat may be respectively selected for each control system among the plurality of motors respectively controlled by second control system 62 and third control system 63 in the manner of the aforementioned first embodiment, temperature sensors may be respectively installed for each selected motor (at two locations on the inlet side and outlet side of each motor), and coolant temperature may be controlled in the same manner as described in the aforementioned first embodiment based on these temperature sensors.

In addition, as was described as a variation of the aforementioned first embodiment, temperature sensors may be respectively installed on the outlet side for a plurality of motors for which temperature is controlled by second control system 62 and for a plurality of motors for which temperature is controlled by third control system 86 (while temperature sensors on the inlet side are only installed for a representative motor 1 for both control systems), and the flow volume of coolant that flows to each motor may be adjusted with respective valves so as to control the outlet side temperature to a predetermined value (so as to control the outlet side temperature of coolant that circulates through each motor provided in reticle stage 2 in the case of the second control system, and so as to control the outlet side temperature of coolant that circulates through each motor provided in wafer stage 5 in the case of the third control system 86).

In the present embodiment, as a result of a third detection unit in the form of temperature sensor 69 detecting the temperature of coolant that circulates through projection optics PL, and controller 67 controlling the driving of temperature regulator 87 by setting the coolant circulation conditions (third circulation conditions) based on the detection results in first control system 61, the temperature of projection optics PL is managed within a range of ±0.01° C. IN addition, as a result of temperature sensor 76 detecting the temperature of coolant that circulates through reticle stage 2, and controlling the driving of temperature regulator 88 based on the detection results in second control system 62, the temperature of reticle stage 2 is managed within a range of ±0.1° C. Similarly, as a result of temperature sensor 79 detecting the temperature of coolant that circulates through wafer stage 5, and controlling the driving of temperature regulator 89 based on the detection results in third control system 86, the temperature of wafer stage 5 is managed within a range of ±0.1° C.

In this manner, in addition to similar operation and effects as the aforementioned first embodiment being obtained in the present embodiment, since control systems 61, 62 and 86 respectively and independently control the temperatures of projection optics PL, reticle stage 2 and wafer stage 5, high-precision temperature management can be carried out corresponding to the amount of heat generated by each control target.

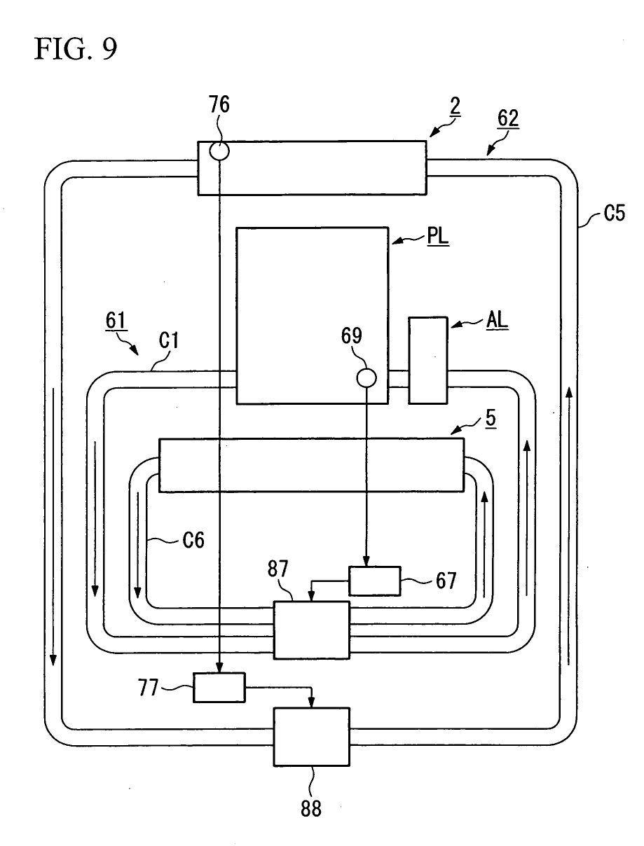

FIG. 9 shows a third embodiment of a projection system as claimed in the present invention.

In the present embodiment, the projection optics and wafer stage 5 are designated as temperature control targets of first control system 61, while reticle stage 2 is designated as the temperature control target of second control system 62. In first control system 61, the temperatures of circulation system C1, which circulates through projection optics PL and alignment system AL, and circulation system C6, which circulates through wafer stage 5, are controlled by a single temperature regulator 87. This temperature control is carried out sensor 69 detecting the temperature of coolant that circulates through projection optics PL, and controller 67 controlling the driving of temperature regulator 87 based on the detected results. In this case, the temperature of wafer stage 5 is controlled to a range within ±0.01° C. in the same manner as projection optics PL. Furthermore, in second control system 62, reticle stage 2 is independent from first control system 61, and its temperature is controlled within a range of ±0.1° C.

In the present embodiment as well, the temperature of reticle stage 2, which generates the largest amount of heat, can be controlled independently and separately from projection optics PL and wafer stage 5, which generate comparatively small amounts of heat, and the optimum cooling conditions can be set corresponding to the amount of heat generated by each component. Moreover, in comparison with the second embodiment, since the coolant temperatures of two circulation systems C1 and C6 can be controlled with first control system 61, the system constitution can be simplified.

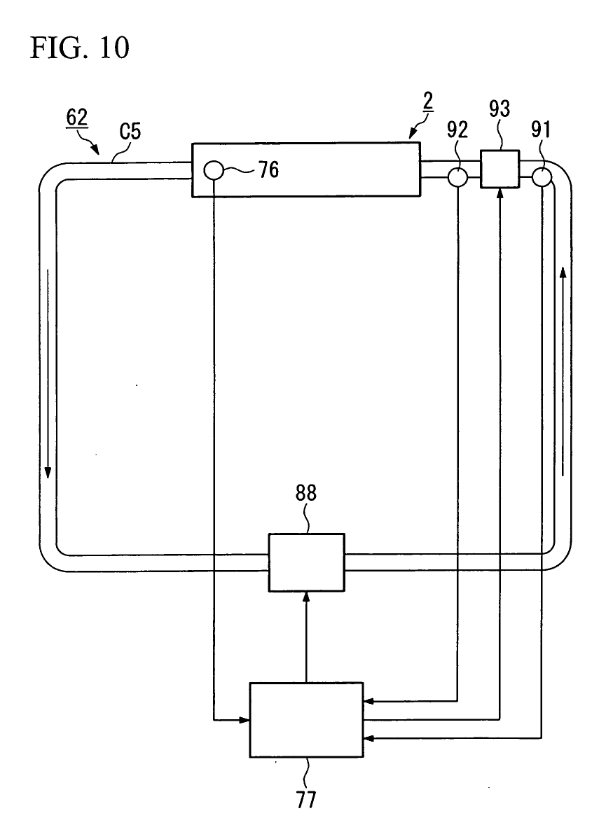

FIG. 10 is a drawing showing a fourth embodiment of a projection system of the present invention. Furthermore, only the temperature control system for reticle stage 2 is shown in this drawing.

As shown in this drawing, temperature sensors 91 and 92 along with a second regulator in the form of Peltier device 93 are provided in second control system 62 in contrast to the embodiment containing temperature sensor 76, controller 77 and temperature regulator 88 shown in FIGS. 8 and 9. Peltier device 93 is arranged closer to reticle stage 2 than temperature regulator 88, and its driving is controlled by controller 77. Temperature sensor 91 is arranged upstream from Peltier device 93, while temperature sensor 92 is arranged downstream from Peltier device 93, and the coolant temperature detected by each temperature sensor 91 and 92 is output to controller 77. Together with controlling the driving of temperature regulator 88 based on the temperature detection results of temperature sensor 76, controller 77 controls the driving of Peltier device 93 based on the temperature detection results of temperature sensors 91 and 92. The other aspects of the constitution are the same as the aforementioned second and third embodiments.

In the aforementioned constitution, controller 77 excessively cools the coolant temperature of circulation system C5 to a temperature lower than a predetermined temperature by controlling temperature regulator 88. Controller 77 then raises the coolant temperature to the predetermined temperature by supplying current to Peltier device 93 based on the coolant temperatures detected by temperature sensors 91 and 92.

In the present embodiment, temperature can be controlled to a predetermined temperature by circulating excessively cooled coolant even if a sudden increase in temperature occurs during driving of reticle stage 2, thereby making it possible to easily accommodate even rapid temperature changes in the equipment. Furthermore, the present embodiment is not limited to a constitution in which coolant is excessively cooled with temperature regulator 88 and heated with Peltier device 93, but rather a constitution may also be employed in which coolant is excessively heated with temperature regulator 88 and then cooled with Peltier device 93. In addition, a heater may be used instead of Peltier device 93 in the case of heating excessively cooled coolant.

Continuing, an explanation is provided of a fifth embodiment of a projection system of the present invention.

In the third embodiment shown in FIG. 9, for example, a constitution is employed in which controller 67 controls the driving of temperature regulator 87 based on the detection results of temperature sensor 69 in first control system 61, while controller 77 controls the diving of temperature regulator 88 based on the detection results of temperature sensor 76 in second control system 62. In the present embodiment, however, controller 67 controls the driving of temperature regulator 87 by calculating the amount of heat generated accompanying driving of wafer stage 5 and setting the coolant temperature based on that calculated amount of heat based on data relating to exposure processing (exposure recipe) without providing these temperature sensors 69 and 76. Similarly, in second control system 62, controller 77 controls the driving of temperature regulator 88 by calculating the amount of heat generated accompanying driving of reticle stage 2 and setting the coolant temperature based on the calculated amount of heat based on exposure data.

As a specific example of this control method, an operator (user) selects a process program on an OA panel, and then calculates the amount of electrical power applied to motor driving along with the amount of heat generated in a calculation circuit from the selected process information and information registered for exposure data to control the driving of temperature regulators 87 and 88.

The present embodiment is able to contribute to compact system size and reduced costs since it is not necessary to provide temperature sensors or other temperature detection units. Furthermore, a constitution may also be employed in which the ratio between the driving voltage applied to the motors and the amount of heat generated (amount of temperature change) is determined for each motor, and flow volume is regulated corresponding to the ratio with driving voltage.

Furthermore, in each of the aforementioned embodiments, although constitutions were employed in which the temperature of a control target is controlled by adjusting coolant flow volume, these embodiments are not limited to this, but rather the constitution should include at least one of coolant temperature, flow rate or flow volume. In addition, although a constitution is employed in the aforementioned embodiments in which the temperature regulators and pumps for driving coolant are partially shared, various other constitutions may also be employed such as that in which they are provided separately for each control target (circulation system) or that in which they are shared by all circulation systems. For example, in the case of both a cooler and heater being provided, a cooler may be provided for each control target while sharing the heater. In this case, final temperature regulation is carried out by the cooler.

In addition, although each of the aforementioned embodiments employ a constitution in which the simple average is determined from the coolant temperature before circulating through stages 2 and 5 and the coolant temperature after having circulated through stages 2 and 5, a weighted average may be determined instead. Examples of methods involving the use of a weighted average are indicated as follows. (1) In the case the distance from the motor or other heat source to the installation position of the inlet side temperature sensor differs from the distance from the heat source to the installation position of the outlet side temperature sensor, weighting is performed corresponding to distance by, for example, increasing the weight of the detection results for the temperature sensor having the shorter distance. (2) In the case the material that composes the vicinity of the inlet of the motor or other heat source differs from the material that composes the vicinity of the outlet, then weighting is performed corresponding to the properties or quality or character of that material such as its coefficient of thermal conductivity. (3) In the case a separate heat source is present near the inlet or near the outlet, weighting is performed corresponding to the presence of that separate heat source and the amount of heat generated. For example, in the case a separate heat source is present in a flow path, the weight of the temperature sensor output is increased on the side closer to the separate heat source. In addition, in the case a separate heat source is present outside a flow path, since heat generated by the separate heat source is transmitted to the temperature sensor through the air, the weight of the temperature sensor output closer to the separate heat source is increased. (4) When measuring the baseline, the detected temperature of the inlet side temperature sensor, detected temperature of the outlet side temperature sensor and control temperature of the coolant (control temperature calculated with the simple average) are stored in memory as a set with the measured baseline amount (or amount of baseline shift), and this storage operation is repeated whenever baseline is measured. The extent to which the inlet side temperature or outlet side temperature should be weighted so as to minimize baseline shift is then estimated and calculated based on the plurality of accumulated data sets. Weighting averaging is then carried out based on the estimated weight.

In addition, although a constitution is employed in each of the aforementioned embodiments in which the same type of coolant (HFE) is used, a different coolant may be used for each circulation system corresponding to the temperature control accuracy and installation environment required by each circulation system.

Furthermore, although each of the aforementioned embodiments is composed so that temperature is controlled for a single temperature control target (motor, etc.) with coolant that circulates in a single direction, the present invention is not limited to this, but rather temperature may be controlled using coolant that circulates in a plurality of directions.

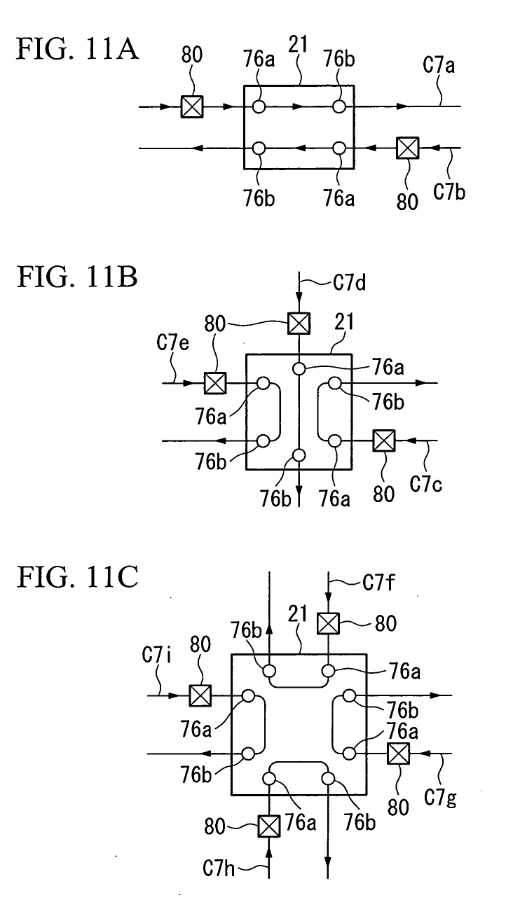

For example, as shown in FIG. 11A, circulation systems C7a and C7b that circulate in two different directions are arranged for a control target 21 (the explanation here uses the example of a mover 21 of Y linear motor 15), and coolant is made to circulate from mutually opposite directions in each circulation system C7a and C7b (the coolant inlet side and outlet side are reversed between the two circulation systems). As a result of composing in this manner, a temperature gradient that ought to occur in control target 21 in the case of only providing one circulation system (that which occurs between the inlet side and outlet side of a single circulation system) can be eliminated, thereby enabling temperature to be controlled with higher precision and more accurately.

In addition, as shown in FIGS. 11B and 11C, as a result of controlling the temperature of a control target by subdividing the temperature regulation section (flow paths and lines), a state can be created in which there is no temperature gradient in the control target. In FIG. 11B, three different circulation systems (flow paths, lines) C7c, C7d and C7e are provided for control target 21 as shown in the drawing, and coolant is circulated through each system in the directions indicated with arrows in the drawing. In addition, in FIG. 11C, four different circulation systems (flow paths, lines) C7f, C7g, C7h and C7i are provided for control target 21 as shown in the drawing, and coolant is circulated through each circulation system in the directions indicated with arrows in the drawing. As a result of employing a constitution in which temperature control is subdivided in this manner, the temperature gradient in the control target can be eliminated.

Furthermore, although the directions of coolant circulation are in the opposite directions as shown in the drawings in the circulation systems arranged in opposition to each other in the manner of circulation systems C7c and C7e of FIG. 11B or in the manner of circulation systems C7f and C7h or circulation systems C7g and C7i of FIG. 11C, this is desirable from the viewpoint of eliminating temperature gradients.

Furthermore, although the constitutions employed in the examples of FIGS. 11A through 11C provide temperature sensors 76a and 76b at the respective inlet and outlet sides of each circulation system C7a through C7i, temperature sensors may also be provided for any one circulation system only. Alternatively, temperature sensors may also be provided only at the outlet sides of each circulation system. The manner in which these temperature sensors are used is the same as in each of the aforementioned embodiments.

The constitutions shown in FIGS. 11A through 11C are particularly effective in cases in which the control target is large (long) and in cases in which the amount of heat generated by the control target (amount of driving) is large. Possible examples of such control targets include mover 21 of Y linear motor 15 (motor that drives in the scanning direction) of reticle coarse movement stage 16, stator 20 that extends over a long distance in the Y direction, and mover 36 or stator 37 of linear motor 33 of the wafer stage. In addition, the constitutions shown in FIGS. 11(A) through 11(C) are also effective for control targets at locations requiring the absence of a temperature gradient in particular. Possible examples of such control targets include a drive source arranged near a wafer or reticle (such as voice coil motors 81 through 83 or Y voice coil motor 17Y of the reticle fine movement stage). Locations where the constitutions of FIG. 11 are applied are not limited to the locations described here, but rather the constitutions shown in FIG. 11 should be employed at locations where the absence of a temperature gradient is desired.

Furthermore, the substrate in the embodiments of the present invention is not limited to a semiconductor wafer W for a semiconductor device, but rather a glass substrate for a liquid crystal display device, ceramic wafer for a thin film magnetic head, or mask or reticle raw substrate (synthetic quartz or silicon wafer) used in an exposure system and so forth may also be applied.

In addition to a step-and-scan type of scanning exposure system (scanning stepper: U.S. Pat. No. 5,473,410) that scans and exposes a pattern of reticle R by synchronously moving a reticle R and wafer W, and step-and-repeat type of projection and exposure system (stepper) that exposes a pattern of a reticle R in a state in which reticle R and wafer W are stationary and then sequentially moving wafer W in steps, can also be applied for exposure system 1.

The type of exposure system 1 is not limited to an exposure system for production of semiconductor devices that exposes a semiconductor device pattern on a wafer W, but rather the present invention can also be applied to a wide range of types of systems such as an exposure system for production of liquid crystal display devices and exposure systems for producing thin film magnetic heads, image capturing devices (CCD) or reticles.

In addition, the light source of the illumination light for exposure is not limited to bright lines (g lines: 436 nm), h lines (404.7 nm) or i lines (365 nm) generated from an ultra-high-pressure mercury lamp, KrF excimer laser (248 nm), ArF excimer laser (193 nm) or F₂ laser (157 nm), but rather charged particle beams such as X-rays and electron beams can also be used. For example, in the case of using an electron beam, thermoelectron-radiating lanthanum hexaboride (LaB₆) or tantalum (Ta) can be used as an electron gun. Moreover, in the case of using an electron beam, the constitution may use a reticle R or the constitution may form a pattern directly on a wafer without using reticle R. In addition, high-frequency waves such as from a YAG laser or semiconductor laser may also be used.

The magnification factor of the projection optics PL is not limited to a reducing system, but may also be an equal size or enlarging system. In addition, in the case of using deep ultraviolet light from an excimer laser and so forth for the projection optics PL, a material such as quartz or quartzite is used through which ultraviolet rays pass, in the case of using an F₂ laser or X-rays, dioptric or refractive optics are used (in which reticle R is also of the reflective type), and in the case of using an electron beam, electronic optics composed of an electronic lens and deflector should be used. Furthermore, it goes without saying that the optical path through which an electron beam passes must be in a vacuum. In addition, the present invention can also be applied to a proximity exposure system that exposes a pattern of a reticle R by adhering reticle R and wafer W without using projection optics PL.

In the case of using a linear motor (refer to U.S. Pat. Nos. 5,623,853 or 5,528,118) for wafer stage 5 and reticle stage 2, an air floating system that uses air bearings or a magnetic floating system that uses Lorentz's force or reactance force may be used. In addition, each stage 2 and 5 may be of a type that moves along guides, or be of a guide-less type in which guides are not provided.

A horizontal motor may be used for the driving mechanisms of stages 2 and 5 to drive each stage 2 and 5 by electromagnetic force by opposing a magnet unit (permanent magnets), in which the magnets are arranged two-dimensionally, and an armature unit, in which coils are arranged two-dimensionally. In this case, one of the magnet unit and armature unit should be connected to stages 2 and 5, and the other of the magnet unit and armature unit should be provided on the moving surface (base) of stages 2 and 5.

As has been described above, exposure system 1 of the embodiments of the present application is produced by assembling each of the subsystems that contain each of the constituent features listed in the scope of claim for patent of the present application so as to maintain a predetermined mechanical precision, electrical precision and optical precision. In order to ensure each of these precisions, adjustments for achieving optical precision for each of the optics, adjustments for achieving mechanical precision for each of the mechanical systems, and adjustments for achieving electrical precision for each of the electrical systems are carried out before and after assembly. The process for assembling the exposure system from each of the subsystems includes mechanical connections, electrical circuit wiring connections and pneumatic circuit line connections between each subsystem. It goes without saying that there is an assembly step for each subsystem prior to the process for assembling the exposure system from each of the subsystems. Once the process for assembling the exposure system from each of the subsystems has been completed, overall adjustments are performed to ensure each of the precisions for the entire exposure system. Furthermore, the exposure system is preferably produced in a clean room where temperature, cleanliness and other factors are controlled.

### INDUSTRIAL APPLICABILITY

As has been explained above, the present invention makes it possible to respectively and independently control and manage temperature even for equipment having different levels of required temperature control precision, and since optimum cooling conditions can be set corresponding to the amount of heat generated by each piece of equipment, baseline shifts resulting from not controlling temperature can be inhibited and worsening of overlay accuracy can be prevented. In addition, the present invention also offers the effect of being able to contribute to compact system size and reduced system costs.

1. An exposure system which projects a pattern image of a reticle held on a reticle stage equipped with a plurality of drive sources onto a substrate held on a substrate stage, through a projection optical system, comprising:
a first control system which sets a temperature of a first liquid and which makes circulate the first liquid for at least one object of the projection optical system and the substrate stage to control the temperature of the object; and
a second control system which sets a temperature of a second liquid independent of the first control system and which makes circulate the second liquid for the reticle stage to control the temperature of the reticle stage,
wherein the first and second control systems have mutually different setting capacities with respect to a size of the temperature range when setting the temperatures of the liquids, and wherein the second control system calculates an amount of heat generated by a predetermined drive source having the largest amount of heat generated, among the plurality of the drive sources on the reticle stage, and sets the temperature of the second liquid based on the calculated amount of heat.

2. An exposure system according to claim 1, wherein the object is the substrate stage, the first control system calculates the amount of heat generated accompanying driving of the substrate stage and sets the temperature of the first liquid based on the calculated amount of heat generated.

3. An exposure system according to claim 2, further comprising:
a first detection unit which respectively detects a temperature of the first liquid before circulating through the object and a temperature of the first liquid after having circulated through the object; and
a second detection unit which respectively detects a temperature of the second liquid before circulating through the reticle stage and a temperature of the second liquid after having circulated through the reticle stage,
wherein the first control system sets the temperature of the first liquid based on the detection results of the first detection unit, and the second control system sets the temperature of the second liquid based on the detection results of the second detection unit.

4. An exposure system according to claim 1, wherein the second control system contains a plurality of branching flow paths through which the second liquid is circulated to each of the plurality of drive sources, and contains a plurality of regulating units installed in the plurality of branching flow paths at locations prior to where the second liquid is supplied to each of the plurality of drive sources, which regulates a flow volume of the second liquid that is supplied to each of the drive sources.

5. An exposure system according to claim 4, wherein the second control system additionally has a calculation unit which calculates a ratio of the amounts of heat generated among the plurality of drive sources, and wherein the plurality of regulating units respectively regulate the flow volume of the second liquid that respectively circulates to each of the plurality of drive sources corresponding to the calculated ratio of the amount of heat generated.

6. An exposure system according to claim 1, further comprising:
a first temperature detection unit provided near said predetermined drive source, and which detects the temperature of the second liquid before circulating to the predetermined drive source; and
a second temperature detection unit provided near said predetermined drive source, and which detects the temperature of the second liquid after having circulated through the predetermined drive source,
wherein the second control system controls the temperature of the second liquid based on the detection results of the first and second temperature detection units.

7. An exposure system according to claim 1, wherein the first control system is targeted at control of at least the projection optical system; and further comprising a third control system which sets a temperature of a third liquid independently of the first and second control systems, and which controls a temperature of the substrate stage by circulating the third liquid for which temperature has been set to the substrate stage.

8. An exposure system according to claim 1, wherein the first control system is targeted at control of both the projection optical system and the substrate stage.

9. A exposure system which projects a pattern image of a reticle held on a reticle stage onto a substrate held on a substrate stage, through a projection optical system, comprising:
a first control system which sets a first circulation condition when circulating a first liquid for at least one object of the projection optical system and the substrate stage, and which controls a the temperature of the object by circulating the first liquid under the first circulation condition;
a second control system which sets a second circulation condition when circulating a second liquid for the reticle stage independent of the first circulation condition, and which controls a temperature of the reticle stage by circulating the second liquid under the second circulation condition;
a first detection unit which respectively detects a first temperature of the first liquid before circulating for the object and a second temperature of the first liquid after having circulated for the object; and
a second detection unit which respectively detects a third temperature of the second liquid before circulating for the reticle stage and a fourth temperature of the second liquid after having circulated for the reticle stage,
wherein the first control system performs weighed average operation that provides predetermined weights to the first and second temperatures, respectively, to set the first circulation condition based on the temperatures derived by the weighed average operation, and the second control system performs weighed average operation that provides predetermined weights to the first and second temperatures, respectively, to set the second circulation condition based on the temperatures derived by the weighed average operation.

10. An exposure system according to claim 9, wherein the first circulation condition include at least one of a temperature, flow rate and flow volume of the first liquid that is set before the first liquid is circulated for the object, and wherein the second circulation condition include at least one of a temperature, flow rate and flow volume of the second liquid that is set before the second liquid is circulated for the reticle stage.

11. An exposure system according to claim 9, wherein the reticle stage is equipped with a plurality of drive sources, and wherein the second detection unit contains a first sensor provided near a predetermined drive source that generates the largest amount of heat among the plurality of drive sources on the reticle stage, which detects the temperature of the second liquid before circulating to the predetermined drive source, and a second sensor provided near the predetermined drive source which detects the temperature of the second liquid after having been circulated to the predetermined drive source.

12. An exposure system according to claim 11, wherein the second control system contains a plurality of branching flow paths through which the second liquid is circulated to each of the plurality of drive sources, and a plurality of regulating units installed in the plurality of branching flow paths at locations prior to where the second liquid is supplied to each of the plurality of drive sources, and which regulates the flow volume of the second liquid that is supplied to each of the drive sources.

13. An exposure system according to claim 12, wherein the second control system additionally has a calculation unit which calculates a ratio of the amounts of heat generated among the plurality of drive sources, and wherein the plurality of regulating units respectively regulate the flow volume of the second liquid that respectively circulates to each of the plurality of drive sources corresponding to the calculated ratio of the amount of heat generated.

14. An exposure system according to claim 9, wherein the first control system sets at least the substrate stage as a controlled system; and further comprising:
a third control system which sets a third temperature condition when a third liquid circulates to the projection optical system independently of the first and second control systems, and which controls the temperature of the projection optical system by circulating the third liquid under the third circulation condition; and
a third detection unit which detects the temperature of the third liquid that circulates to the projection optical system,
wherein the third control system sets the third circulation conditions based on the detection results of the third detection unit.

15. An exposure system which projects a pattern image of a reticle held on a reticle stage onto a substrate held on a substrate stage, through a projection optical system, the reticle stage and substrate stage each provided with a plurality of drive sources, the exposure system comprising:
a first control system which sets, among a plurality of controlled systems including the drive sources and projection optical system, as a first controlled system a plurality of controlled systems for which the amount of heat generation or amount of temperature change is within a first predetermined amount, and which makes circulate a first liquid to the first controlled system under a first circulation condition to control the temperature of the first controlled system;
a first temperature detection unit provided near a controlled system having the largest amount of heat generated or largest temperature change among the controlled systems, and which detects a temperature of the first liquid;
a second control system which sets, among the drive sources and the projection optical system, as a second controlled system the one for which the amount of heat generation or amount of temperature change is in excess of the first predetermined amount, and which makes circulate a second liquid to the second controlled system under a second circulation condition to control the temperature of the second controlled system; and
a second detection unit provided near a controlled system having the largest amount of heat generated or largest temperature change among the second controlled system, and which detects a temperature of the second liquid,
wherein the first and second control systems respectively set the first and second circulation conditions based on the detection results of the first and second detection units.

16. An exposure system according to claim 15, wherein the first circulation condition include at least one of a temperature, flow rate and flow volume of the first liquid that is set before the first liquid is circulated for the object, and the second circulation condition include at least one of a temperature, flow rate and flow volume of the second liquid that is set before the second liquid is circulated for the reticle stage.

17. An exposure system according to claim 15, wherein the first controlled system includes the projection optics and a portion of the drive sources provided in the substrate stage, and the second controlled system includes a plurality of drive sources provided in the reticle stage.

18. An exposure system according to claim 15, wherein the second controlled system includes a plurality of drive sources provided in the reticle stage and a plurality of drive sources provided in the substrate stage, and wherein the second control system contains a first temperature management section that manages the temperatures of the plurality of drive sources provided in the reticle stage, and a second temperature management section that manages the temperatures of the plurality of drive sources provided in the substrate stage independently of the first temperature management section.

19. An exposure system according to claim 1, wherein the first control system carries out the setting based on the average temperature between the temperature of the first liquid before circulating for the controlled systems and the temperature of the first liquid after having circulated for the controlled system, and the second control system carries out the setting based on the average temperature between the temperature of the second liquid before circulating for the reticle stage and the temperature of the second liquid after having circulated for the reticle stage.

20. An exposure system according to claim 1, wherein the second control system contains a first regulator that excessively cools or excessively heats the second liquid beyond a predetermined temperature, and a second regulator installed closer to the reticle stage than the first regulator that regulates the temperature of the second liquid for which the temperature has been set by the first regulator to the predetermined temperature.

21. An exposure system according to claim 9, wherein each liquid used to control the temperatures is the same type of liquid.

22. An exposure system according to claim 15, wherein each liquid used to control the temperatures is the same type of liquid.

23. An exposure system according to claim 9, wherein at least one of the first control system and the second control system has a plurality of circulation flow paths during circulation of the liquid to a single controlled system.

24. An exposure system according to claim 15, wherein at least one of the first control system and the second control system has a plurality of circulation flow paths during circulation of the liquid to a single controlled system.

25. An exposure system according to claim 24, wherein the circulation direction of a coolant that circulates through each of the plurality of circulation flow paths to the controlled system is mutually different for each of the circulation flow paths.

26. An exposure system according to claim 23, wherein the circulation direction of a coolant that circulates through each of the plurality of circulation flow paths to the controlled system is mutually different for each of the circulation flow paths.

27. An exposure system which projects a pattern image of a reticle held on a reticle stage onto a substrate held on a substrate stage, through a projection optical system, the reticle stage and substrate stage each provided with a plurality of drive sources, the exposure system comprising:
a control system which sets as a controlled system any one of the drive sources and the projection optical system, and which controls a temperature of the controlled system in order to suppress a temperature variation of the controlled system caused by driving the controlled system, by circulating a liquid to the controlled system; and
a detection unit which detects a first temperature of the liquid before circulating for the controlled system and a second temperature of the liquid after having circulated for the controlled system, respectively,
wherein the control system performs weighed average operation that provides predetermined weights to the first and second temperatures, respectively, to control the temperature of the liquid to be circulated for the controlled system based on the temperatures derived by the weighed average operation,

28. An exposure system according to claim 27, wherein the weight provided for the weighed average operation is given based on a distance between the controlled system and a location where the temperature detection unit detects each temperature.

29. An exposure system according to claim 27, wherein the weight provided for the weighed average operation is given based on a character of a material near a location where the temperature detection unit detects each temperature.

30. An exposure system according to claim 27, wherein the weight provided for the weighed average operation is given based on another heat source near a location where the temperature detection unit detects each temperature.

31. An exposure system according to claim 27, wherein the weight provided for the weighed average operation is given based on a weight derived by a result of an estimation operation to suppress a base line variation.

32. A device production process comprising:
a step in which a pattern formed on the reticle is transferred onto the substrate using an exposure system according to claim 1.

33. A device production process comprising:
a step in which a pattern formed on the reticle is transferred onto the substrate using an exposure system according to claim 9.

34. A device production process comprising:
a step in which a pattern formed on the reticle is transferred onto the substrate using an exposure system according to claim 15.

35. A device production process comprising:
a step in which a pattern formed on the reticle is transferred onto the substrate using an exposure system according to claim 27.
